(19) United States
(12) Patent Application Publication
(10) Pub. No.: US 2005/0180332 A1
(43) Pub. Date: Aug. 18, 2005

(54) Low latency interleaving and deinterleaving

(75) Inventors: Joonsuk Kim, San Jose, CA (US); Christopher James Hansen, Sunnyvale, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/005,100

(22) Filed: Dec. 7, 2004

Related U.S. Application Data
(60) Provisional application No. 60/544,605, filed on Feb. 13, 2004.
(60) Provisional application No. 60/545,854, filed on Feb. 19, 2004.
(60) Provisional application No. 60/581,846, filed on Jun. 22, 2004.

(51) Int. Cl. G06F 12/00

(52) U.S. Cl. 370/244; 714/746

(57) ABSTRACT

A method for interleaving contents of a frame begins by partitioning the frame into a plurality of frame segments, wherein the frame includes x rows of y columns of the content, and wherein at least one of the plurality of frame segments includes x rows of z columns of the content, where z is less than y. The method continues by storing the content of the x rows of z columns of the at least one of the plurality of frame segments in accordance with a first pattern to produce stored content. The method continues by retrieving the stored content in accordance with a second pattern to produce interleaved content.

### REFERENCE TO RELATED APPLICATIONS

This application claims priority of U.S. Provisional Patent Applications Ser. No. 60/544,605, filed on Feb. 13, 2004, Ser. No. 60/545,854, filed on Feb. 19, 2004 and Ser. No. 60/581,846, filed on Jun. 22, 2004. The subject matter of this earlier filed application is hereby incorporated by reference.

### BACKGROUND OF THE INVENTION

1. Filed of the Invention

The present invention relates generally to wireless communications. More particularly, the present invention is directed to processes of and apparatuses for interleaving and deinterleaving of data in wireless communication.

2. Description of Related Art

Communication systems support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, BLUETOOTH™, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

For each wireless communication device to participate in wireless communications, it may include a built-in radio transceiver (i.e., receiver and transmitter) or may be coupled to an associated radio transceiver (e.g., a station for in-home and/or in-building wireless communication networks, RF modem, etc.). The transmitter may include a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

The receiver may be coupled to the antenna and include a low noise amplifier, one or more intermediate frequency stages, a filtering stage, and a data recovery stage. The low noise amplifier receives inbound RF signals via the antenna and amplifies them. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

Part of the data modulation stage function can include interleaving data to reduce the adverse affects of channel fading. Correspondingly, the data recovery stage may include a deinterleaving function. As is generally understood, deinterleaving is an inverse function of interleaving. For example, to interleave bytes (or bits) of data, the bytes of data may be written into a transmitter's memory on a row by row basis and read out of the memory column by column. The corresponding deinterleaving function may be done by written the bytes of data into a receiver's memory column by column and reading it out on a row by row basis.

An issue arises with the interleaving and deinterleaving functions based on the amount of data being processed. For example, in wireless communication of frames of data, it is common to store an entire frame of data prior to reading it out in an interleaved or deinterleaved manner. In one instance, a frame of data includes 4K bytes worth of data. As the demand for increased data rates intensifies, the latency encountered by interleaving and/or deinterleaving frames of data can limit the efficiency of wireless communication devices. Further, the wireless communication devices should include memory large enough to hold at least one frame of data.

Therefore, a need exists for a method and apparatus that reduces hardware requirements for, and latency of, interleaving and deinterleaving functions within wireless communication devices.

### SUMMARY OF THE INVENTION

In one embodiment, a method for interleaving contents of a frame includes the steps of partitioning the frame into a plurality of frame segments, wherein the frame includes x rows of y columns of contents, and wherein at least one of the plurality of frame segments includes x rows of z columns of the contents, where z is less than y, storing contents of the x rows of z columns of the at least one of the plurality of frame segments in accordance with a first pattern to produce stored content and retrieving the stored content in accordance with a second pattern to produce interleaved content.

Additionally, when y is a multiple of z, the method may include storing contents of the x rows of z columns of a first one of the plurality of frame segments in accordance with the first pattern to produce first stored content, retrieving the first stored content in accordance with the second pattern to produce first interleaved content, storing contents of the x rows of z columns of a second one of the plurality of frame segments in accordance with the first pattern to produce second stored content and retrieving the second stored content in accordance with the second pattern to produce second interleaved content. Also, when y is not a multiple of z such that y=a*z+b, where a is whole number and b is a remainder, for each of the plurality of frame segments corresponding to the a*z term, the method may include storing the content of the x rows of z columns in accordance with the first pattern to produce the stored content and retrieving the stored content in accordance with the second pattern to produce the interleaved content. Additionally, for a remainder frame segment of the plurality of frames that corresponds to the b term, the method includes storing the content of the x rows of z columns in accordance with a third pattern to produce remainder stored content and retrieving the remainder stored content in accordance with a fourth pattern to produce remainder interleaved content.

Also, when b equals one, the method may include storing the content of x rows of one column sequentially to produce the remainder stored content and retrieving the remainder stored content in a same sequential manner to produce remainder interleaved content. Additionally, when b is greater than one, the method may include storing the content of x rows of b columns sequentially across the b columns from row to row of the x rows produce the remainder stored content and retrieving the remainder stored content sequentially down a row of the x rows from column to column of the b columns to produce remainder interleaved content. Additionally, the first pattern may include storing the content of x rows of y columns sequentially across the y columns from row to row of the x rows to produce the stored content and the second pattern may include retrieving the remainder stored content sequentially down a row of the x rows from column to column of the y columns to produce the interleaved content. Also, the first pattern may include storing the content of x rows of y columns sequentially down a row of the x rows from column to column of the y columns to produce the stored content and the second pattern may include retrieving the remainder stored content sequentially across the y columns from row to row of the x rows to produce the interleaved content.

According to another embodiment, a method for deinterleaving contents of a frame includes the steps of partitioning the frame into a plurality of frame segments, wherein the frame includes x rows of y columns of the content, and wherein at least one of the plurality of frame segments includes x rows of z columns of the content, where z is less than y, storing the content of the x rows of z columns of the at least one of the plurality of frame segments in accordance with a first pattern to produce stored content and retrieving the stored content in accordance with a second pattern to produce deinterleaved content.

According to another embodiment, a radio frequency (RF) transmitter includes a baseband processing means for performing an outer encoding function on outbound data to produce outer encoded data, interleaving the outer encoded data to produce interleaved outer encoded data, and converting a portion of the interleaved outer encoded data into outbound baseband signals and a transmitting means for converting the outbound baseband signals into outbound RF signals. The baseband processing means further includes means for partitioning a frame of the outer encoded data into a plurality of frame segments, wherein the frame includes x rows of y columns of bytes of the outer encoded data, and wherein at least one of the plurality of frame segments includes x rows of z columns of bytes of the outer encoded data, where z is less than y, means for storing the bytes of the outer encoded data of the x rows of z columns of the at least one of the plurality of frame segments in accordance with a first pattern to produce stored bytes of the outer encoded data and means for retrieving the stored bytes of the outer encoded data in accordance with a second pattern to produce the portion of the interleaved outer encoded data.

According to another embodiment, a radio frequency (RF) receiver includes receiver means for converting inbound RF signals into inbound baseband signals and baseband processing means for converting the inbound baseband signals into interleaved outer encoded data; deinterleaving the interleaved outer encoded data to produce deinterleaved outer encoded data and performing an outer decoding function on deinterleaved bytes of the interleaved outer encoded data to produce partial inbound data. The baseband processing means further includes means for partitioning a frame of the interleaved outer encoded data into a plurality of frame segments, wherein the frame includes x rows of y columns of bytes of the interleaved outer encoded data, and wherein at least one of the plurality of frame segments includes x rows of z columns of the bytes of the interleaved outer encoded data, where z is less than y, means for storing the bytes of the interleaved outer encoded data of the x rows of z columns of the at least one of the plurality of frame segments in accordance with a first pattern to produce stored bytes of the interleaved outer encoded data and means for retrieving the stored bytes of the interleaved outer encoded data in accordance with a second pattern to produce the deinterleaved bytes of the interleaved outer encoded data.

According to another embodiment, a radio frequency (RF) transceiver includes a baseband processor, configured to perform an outer encoding function on outbound data to produce outer encoded data, to interleave the outer encoded data to produce interleaved outer encoded data, to convert a portion of the interleaved outer encoded data into outbound baseband signals, to convert inbound baseband signals into other interleaved outer encoded data, to deinterleave the other interleaved outer encoded data to produce deinterleaved outer encoded data and to perform an outer decoding function on deinterleaved bytes of the interleaved outer encoded data to produce partial inbound data, a transmitter, configured to convert the outbound baseband signals into outbound RF signals and a receiver, configured to convert inbound RF signals into the inbound baseband signals. The baseband processor further includes a partitioner, configured to partition a frame of the outer encoded data into a plurality of frame segments and to partition a frame of the interleaved outer encoded data into another plurality of frame segments, wherein the frame includes x rows of y columns of bytes of data, and wherein at least one of the plurality of frame segments and the another plurality of frame segments includes x rows of z columns of bytes of the data, where y is less than z, a data storer, configured to store the bytes of the data of the x rows of z columns of the at least one of the plurality of frame segments and the another plurality of frame segments in accordance with a first pattern to produce stored bytes of the outer encoded data and to produce stored bytes of the interleaved outer encoded data and a data retriever, configured to retrieve the stored bytes of the outer encoded data and stored bytes of the interleaved outer encoded data in accordance with a second pattern to produce the portion of the interleaved outer encoded data and to produce the deinterleaved bytes of the interleaved outer encoded data.

### BRIEF DESCRIPTION OF THE SEVERAL VIEWS OF THE DRAWINGS

For the present invention to be easily understood and readily practiced, the present invention will now be described, for purposes of illustration and not limitation, in conjunction with the following figures:

FIG. 1 is a schematic block diagram of a wireless communication device in accordance with one embodiment of the present invention;

FIG. 2 illustrates schematic block diagrams of a transmitter and receiver, with FIG. 2(a) providing a schematic block diagram of an RF transmitter and with FIG. 2(b) providing a schematic block diagram of an RF receiver, in accordance with embodiments of the present invention;

FIG. 3 provides schematic block diagrams of configurations of digital transmitters and receivers, with FIG. 3(a) illustrating a schematic block diagram of a configuration of the digital transmitter processing module and FIG. 3(b) illustrating a schematic block diagram of a configuration of the digital receiver processing module, in accordance with embodiments of the present invention;

FIGS. 4(a) and 4(b) are a schematic block diagram of a transmitter in accordance one embodiment of with the present invention;

FIGS. 5(a) and 5(b) are a schematic block diagram of a receiver in accordance with one embodiment of the present invention;

FIG. 6 is an example of interleaving and deinterleaving, in accordance with one embodiment of the present invention;

FIG. 7 is another example of interleaving and deinterleaving, in accordance with one embodiment of the present invention;

FIG. 8 is yet another example of interleaving and deinterleaving, in accordance with one embodiment of the present invention; and

FIG. 9 is further example of interleaving and deinterleaving, in accordance with one embodiment of the present invention;

FIG. 10 provides simulation results illustrating the benefits of the interleaving/deinterleaving processes of the instant invention, in accordance with one embodiment of the present invention;

FIG. 11 provides simulation results illustrating the benefits of the interleaving/deinterleaving processes of the instant invention, in accordance with one embodiment of the present invention.

### DETAILED DESCRIPTION OF THE PREFERRED EMBODIMENTS

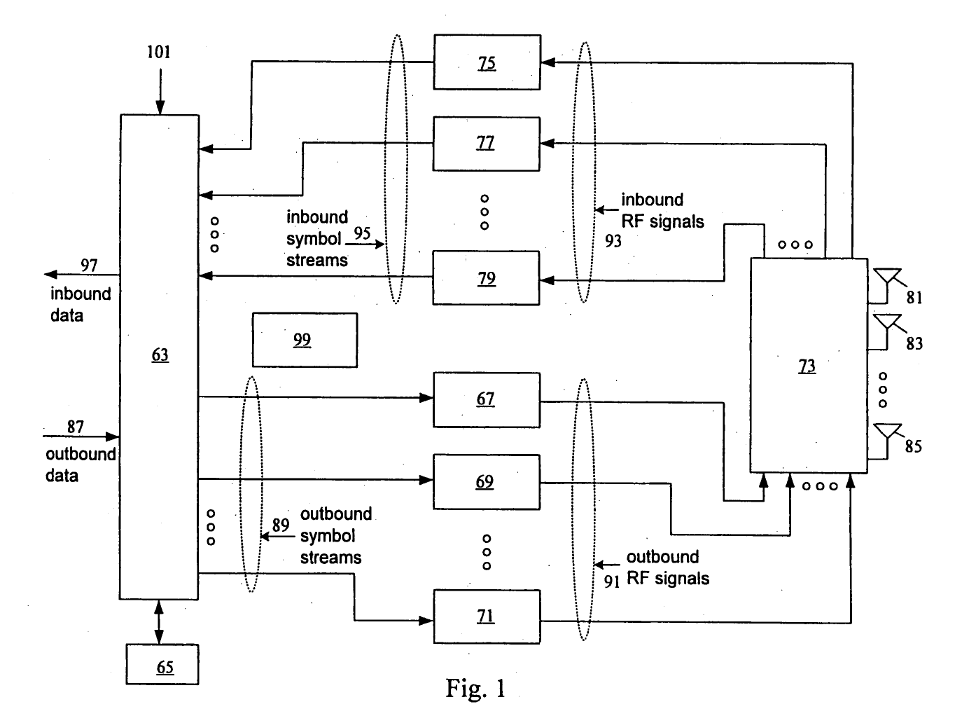

FIG. 1 is a schematic block diagram illustrating a wireless communication device. The device includes a baseband processing module 63, memory 65, a plurality of radio frequency (RF) transmitters 67, 69, 71, a transmit/receive (T/R) module 73, a plurality of antennas 81, 83, 85, a plurality of RF receivers 75, 77, 79, and a local oscillation module 99. The baseband processing module 63, in combination with operational instructions stored in memory 65, execute digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and/or digital baseband to IF conversion. The baseband processing module 63 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 66 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 63 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the baseband processing module 63 receives the outbound data 87 and, based on a mode selection signal 101, produces one or more outbound symbol streams 89. The mode selection signal 101 will indicate a particular mode as are indicated in mode selection tables. For example, the mode selection signal 101 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. A code rate is supplied as well as number of coded bits per subcarrier (NBPSC), coded bits per OFDM symbol (NCBPS), data bits per OFDM symbol (NDBPS), error vector magnitude in decibels (EVM), sensitivity which indicates the maximum receive power required to obtain a target packet error rate (e.g., 10% for IEEE 802.11 a), adjacent channel rejection (ACR), and an alternate adjacent channel rejection (AACR).

The mode selection signal may also indicate a particular channelization for the corresponding mode. The mode select signal may further indicate a power spectral density mask value. The mode select signal may alternatively indicate a rate that has a 5 GHz frequency band, 20 MHz channel bandwidth and a maximum bit rate of 54 megabits-per-second. As a further alternative, the mode select signal 101 may indicate a 2.4 GHz frequency band, 20 MHz channels and a maximum bit rate of 192 megabits-per-second. A number of antennas may be utilized to achieve the higher bandwidths. In this instance, the mode select would further indicate the number of antennas to be utilized. Another mode option may be utilized where the frequency band is 2.4 GHz, the channel bandwidth is 20 MHz and the maximum bit rate is 192 megabits-per-second. Various bit rates ranging from 12 megabits-per-second to 216 megabits-per-second utilizing 2-4 antennas and a spatial time encoding rate may be employed. The mode select signal 101 may further indicate a particular operating mode, which corresponds to a 5 GHz frequency band having 40 MHz frequency band having 40 MHz channels and a maximum bit rate of 486 megabits-per-second. The bit rate may range from 13.5 megabits-per-second to 486 megabits-per-second utilizing 1-4 antennas and a corresponding spatial time code rate.

The baseband processing module 63, based on the mode selection signal 101 produces the one or more outbound symbol streams 89 from the output data 88. For example, if the mode selection signal 101 indicates that a single transmit antenna is being utilized for the particular mode that has been selected, the baseband processing module 63 will produce a single outbound symbol stream 89. Alternatively, if the mode select signal indicates 2, 3 or 4 antennas, the baseband processing module 63 will produce 2, 3 or 4 outbound symbol streams 89 corresponding to the number of antennas from the output data 88.

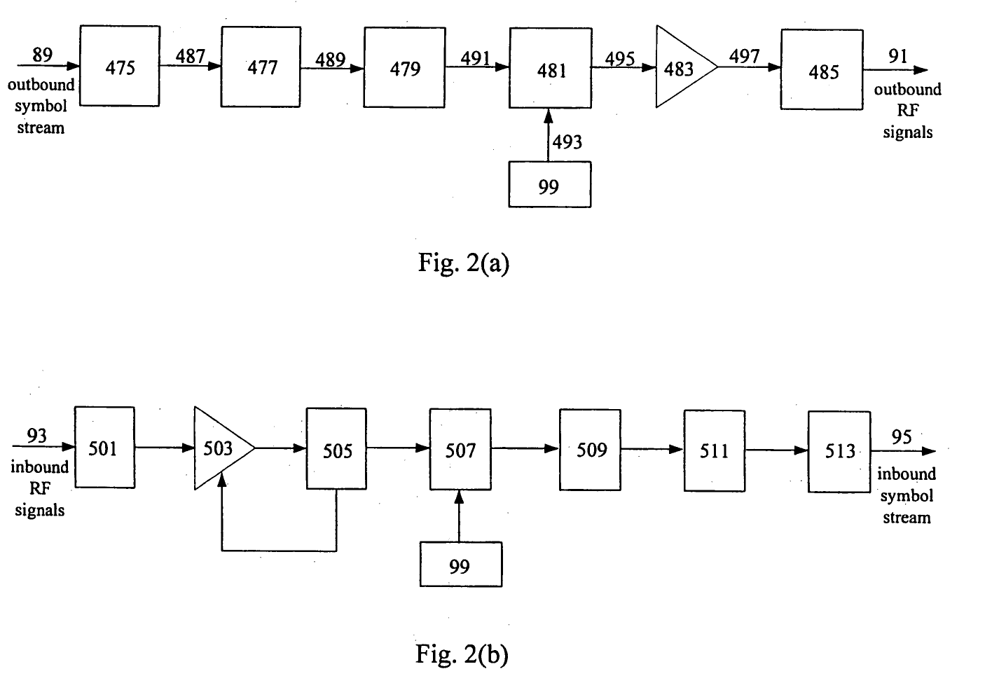

Depending on the number of outbound streams 89 produced by the baseband module 63, a corresponding number of the RF transmitters 67, 69, 71 can be enabled to convert the outbound symbol streams 89 into outbound RF signals 91. The implementation of the RF transmitters 67, 69, 71 will be further described with reference to FIG. 2. The transmit/receive module 73 receives the outbound RF signals 91 and provides each outbound RF signal to a corresponding antenna 81, 83, 85.

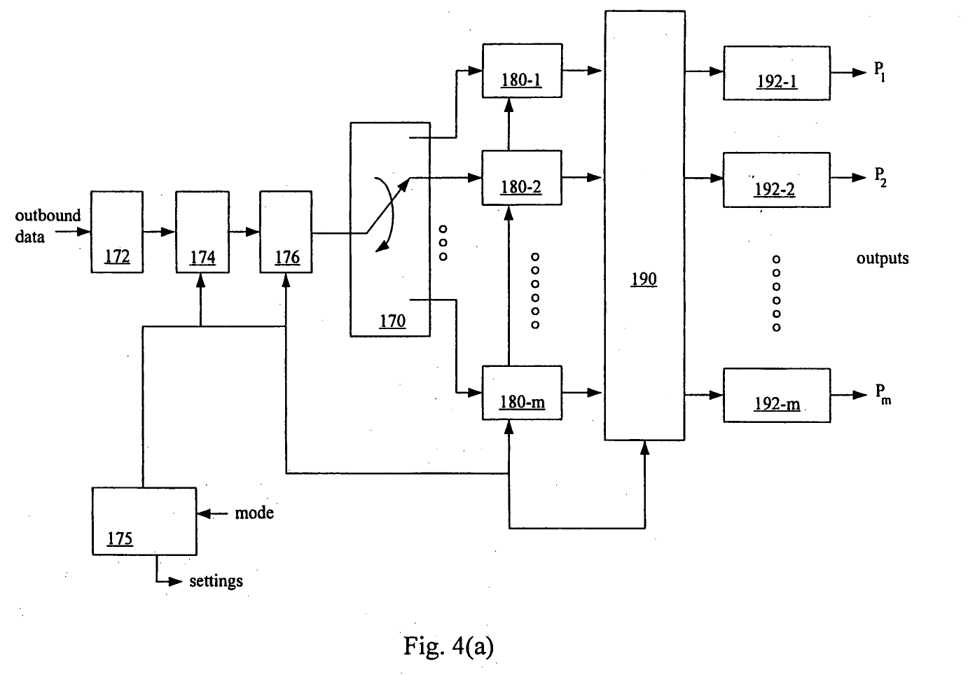

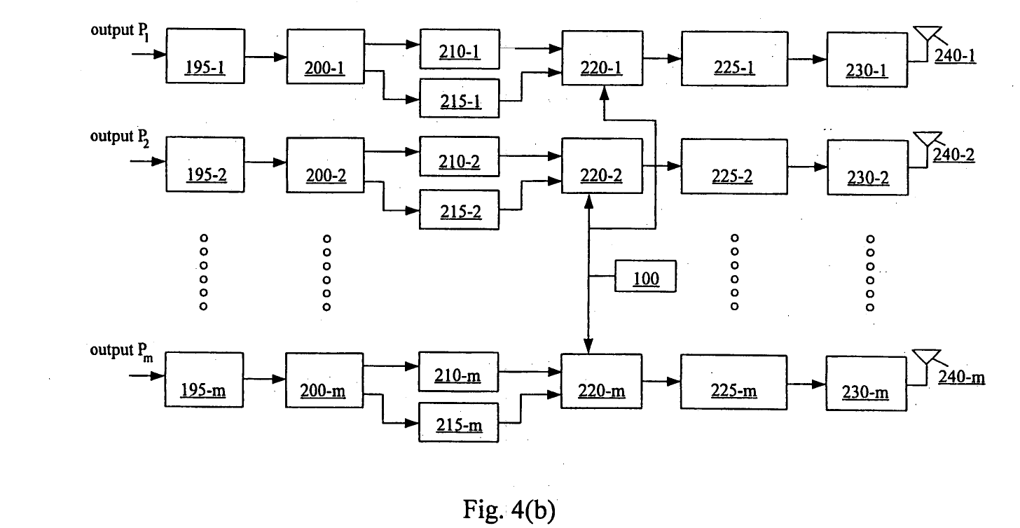

When the radio 60 is in the receive mode, the transmit/receive module 73 receives one or more inbound RF signals via the antennas 81, 83, 85. The T/R module 73 provides the inbound RF signals 93 to one or more RF receivers 75, 77, 79. The RF receiver 75, 77, 79, which will be described in greater detail with reference to FIG. 4, converts the inbound RF signals 93 into a corresponding number of inbound symbol streams 96. The number of inbound symbol streams 95 will correspond to the particular mode in which the data was received. The baseband processing module 63 receives the inbound symbol streams 89 and converts them into inbound data 97.

As one of average skill in the art will appreciate, the wireless communication device of FIG. 1 may be implemented using one or more integrated circuits. For example, the device may be implemented on one integrated circuit, the baseband processing module 63 and memory 65 may be implemented on a second integrated circuit, and the remaining components, less the antennas 81, 83, 85, may be implemented on a third integrated circuit. As an alternate example, the device may be implemented on a single integrated circuit.

FIG. 2(a) is a schematic block diagram of an embodiment of an RF transmitter 67, 69, 71. The RF transmitter may include a digital filter and up-sampling module 475, a digital-to-analog conversion module 477, an analog filter 479, and up-conversion module 81, a power amplifier 483 and a RF filter 485. The digital filter and up-sampling module 475 receives one of the outbound symbol streams 89 and digitally filters it and then up-samples the rate of the symbol streams to a desired rate to produce the filtered symbol streams 487. The digital-to-analog conversion module 477 converts the filtered symbols 487 into analog signals 489. The analog signals may include an in-phase component and a quadrature component.

The analog filter 479 filters the analog signals 489 to produce filtered analog signals 491. The up-conversion module 481, which may include a pair of mixers and a filter, mixes the filtered analog signals 491 with a local oscillation 493, which is produced by local oscillation module 99, to produce high frequency signals 495. The frequency of the high frequency signals 495 corresponds to the frequency of the RF signals 492.

The power amplifier 483 amplifies the high frequency signals 495 to produce amplified high frequency signals 497. The RF filter 485, which may be a high frequency band-pass filter, filters the amplified high frequency signals 497 to produce the desired output RF signals 91.

As one of average skill in the art will appreciate, each of the radio frequency transmitters 67, 69, 71 will include a similar architecture as illustrated in FIG. 2(a) and further include a shut-down mechanism such that when the particular radio frequency transmitter is not required, it is disabled in such a manner that it does not produce interfering signals and/or noise.

FIG. 2(b) is a schematic block diagram of each of the RF receivers 75, 77, 79. In this embodiment, each of the RF receivers may include an RF filter 501, a low noise amplifier (LNA) 503, a programmable gain amplifier (PGA) 505, a down-conversion module 507, an analog filter 509, an analog-to-digital conversion module 511 and a digital filter and down-sampling module 513. The RF filter 501, which may be a high frequency band-pass filter, receives the inbound RF signals 93 and filters them to produce filtered inbound RF signals. The low noise amplifier 503 amplifies the filtered inbound RF signals 93 based on a gain setting and provides the amplified signals to the programmable gain amplifier 505. The programmable gain amplifier further amplifies the inbound RF signals 93 before providing them to the down-conversion module 507.

The down-conversion module 507 includes a pair of mixers, a summation module, and a filter to mix the inbound RF signals with a local oscillation (LO) that is provided by the local oscillation module to produce analog baseband signals. The analog filter 509 filters the analog baseband signals and provides them to the analog-to-digital conversion module 511 which converts them into a digital signal. The digital filter and down-sampling module 513 filters the digital signals and then adjusts the sampling rate to produce the inbound symbol stream 95.

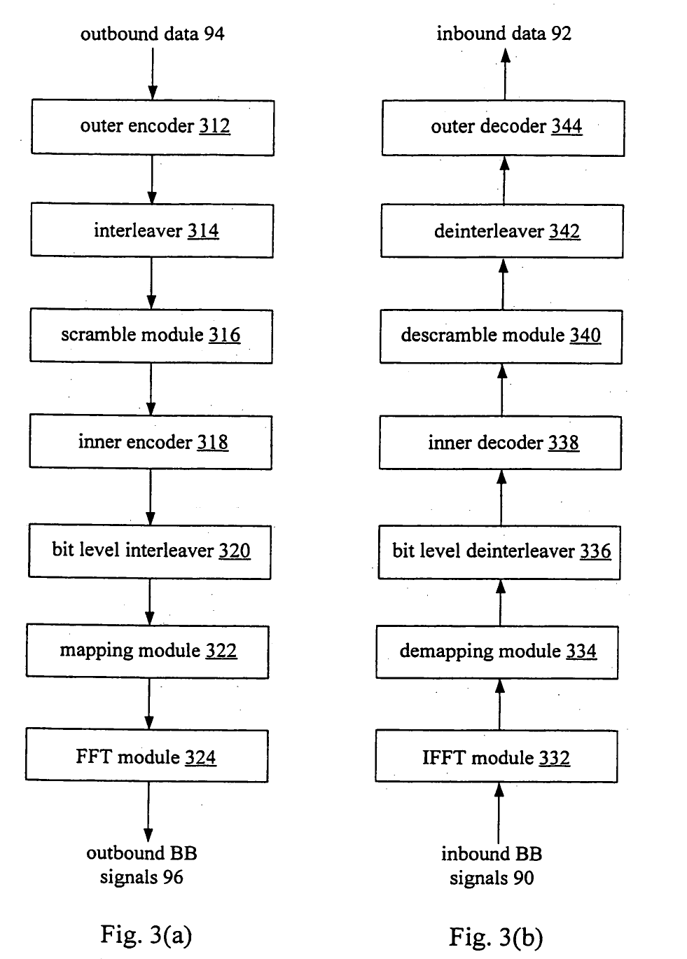

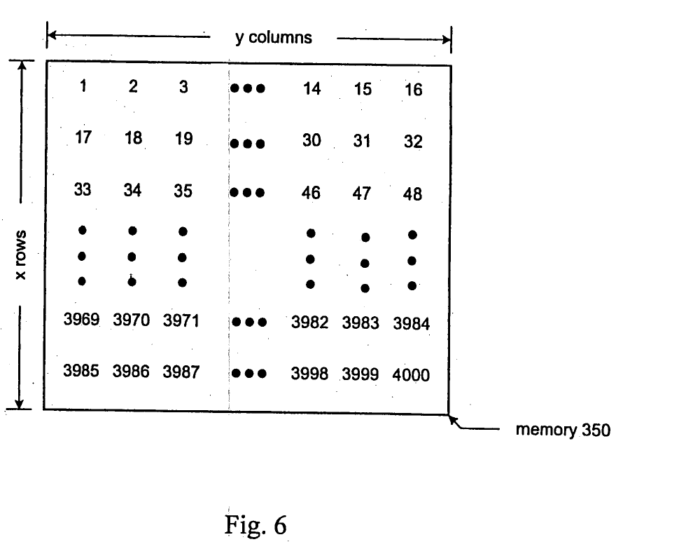

FIG. 3(a) is a schematic block diagram of a configuration of the digital transmitter processing module 76 to include an outer encoder 312, an interleaver 314, which will be described in greater detail with reference to FIGS. 6-9, a scramble module 316, an inner encoder 318, bit level interleaver 320, a mapping module 322, and a fast Fourier transform (FFT) module 324.

The outer encoder 312, which may be a Reed Solomon encoder, receives the outbound data 94 and encodes it into outer encoded data. The interleaver 314 interleaves the outer encoder data to produce interleaved outer encoded data in accordance with one of the embodiments of FIGS. 6-9. The scramble module 316 scrambles the interleaved outer encoded data to produce scrambled data. The bit level interleaver 320 interleaves, at a bit level, the scrambled data to produce bit level interleaved data. The mapping module 322 maps the bit level interleaved data to constellation symbols to produce mapped symbols. The FFT module 324 converts the mapped symbols into time domain signals to produce the outbound baseband signals 96.

FIG. 3(b) is a schematic block diagram of a configuration of the digital receiver processing module 64 that includes an Inverse Fast Fourier transform (IFFT) module 332, a demapping module 334, a bit level interleaving module 336, a descramble module 340, a deinterleaver 342, and an outer decoder 344.

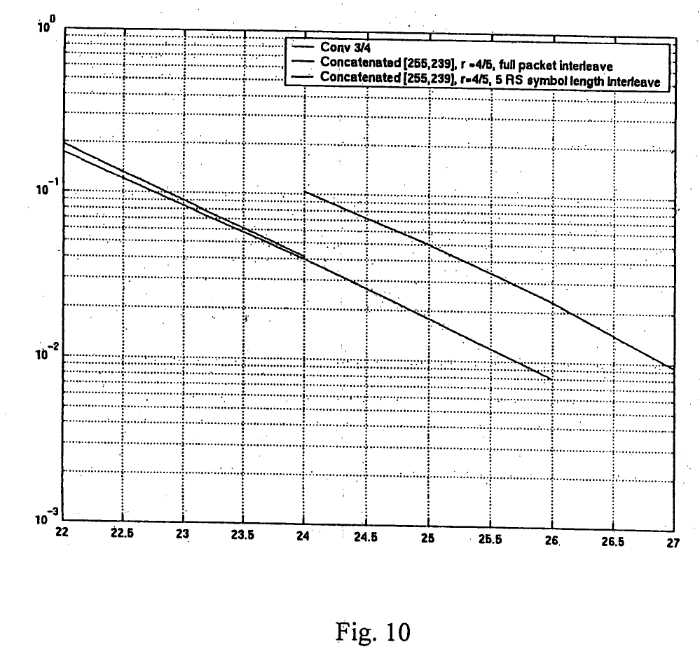

The IFFT converts the inbound BB signals 90 into frequency domain symbols. The demapping module 334 demaps constellation points represented by the symbols into bit level interleaved data. The bit level deinterleaver 336 deinterleaves, at a bit level, the bit level interleaved data to produce scrambled data. The descramble module 340 descrambles the scrambled data to produce interleaved outer encoded data. The deinterleaver 342, which functions in accordance with one or more of the embodiments of FIGS. 10-13, deinterleaves, at a byte level, the interleaved outer encoded data to produce outer encoded data. The outer decoder 344, which may be a Viterbi decoder, decodes the outer encoded data to produce the inbound data 92.

FIGS. 4(a) and 4(b) illustrate a schematic block diagram of a multiple transmitter in accordance with the present invention. In FIG. 4(a), the baseband processing is shown to include a scrambler 172, channel encoder 174, interleaver 176, demultiplexer 170, a plurality of symbol mappers 180-1 through 180-m, a space/time encoder 190 and a plurality of inverse fast Fourier transform (IFFT)/cyclic prefix addition modules 192-1 through 192-m. The baseband portion of the transmitter may further include a mode manager module 175 that receives the mode selection signal and produces settings for the radio transmitter portion and produces the rate selection for the baseband portion.

In operations, the scrambler 172 adds (in GF2) a pseudo random sequence to the outbound data bits 88 to make the data appear random. A pseudo random sequence may be generated from a feedback shift register with the generator polynomial, for example, of S(x)=x⁷+x⁴+1 to produce scrambled data. The channel encoder 174 receives the scrambled data and generates a new sequence of bits with redundancy. This will enable improved detection at the receiver. The channel encoder 174 may operate in one of a plurality of modes. For example, for backward compatibility with standards such as IEEE 802.11(a) and IEEE 802.11(g), the channel encoder has the form of a rate ½ convolutional encoder with 64 states and a generator polynomials of G₀=133₈ and G₁=171₈. The output of the convolutional encoder may be punctured to rates of ½, ⅔rds and ¾ according to the specified rate tables. For backward compatibility with IEEE 802.11(b) and the CCK modes of IEEE 802.11(g), the channel encoder has the form of a CCK code as defined in IEEE 802.11(b). For higher data rates, the channel encoder may use the same convolution encoding as described above or it may use a more powerful code, including a convolutional code with more states, a parallel concatenated (turbo) code and/or a low density parity check (LDPC) block code. Further, any one of these codes may be combined with an outer Reed Solomon code. Based on a balancing of performance, backward compatibility and low latency, one or more of these codes may be optimal.

The interleaver 176, which will be described in greater detail with reference to FIGS. 6-9, receives the encoded data and spreads it over multiple symbols and transmit streams. This allows improved detection and error correction capabilities at the receiver. In one embodiment, the interleaver 176 will follow the IEEE 802.11(a) or (g) standard in the backward compatible modes. For higher performance modes, the interleaver will interleave data over multiple transmit streams. The demultiplexer 170 converts the serial interleave stream from interleaver 176 into M-parallel streams for transmission.

Each symbol mapper 180-m through 180-m receives a corresponding one of the M-parallel paths of data from the demultiplexer. Each symbol mapper locks maps bit streams to quadrature amplitude modulated QAM symbols (e.g., BPSK, QPSK, 16 QAM, 64 QAM, 256 QAM, et cetera) according to the rate tables. For IEEE 802.11(a) backward compatibility, double gray coding may be used.

The map symbols produced by each of the symbol mappers 180 are provided to the space/time encoder 190. Thereafter, output symbols are provided to the IFFT/cyclic prefix addition modules 192-1 through 192-m, which performs frequency domain to time domain conversions and adds a prefix, which allows removal of inter-symbol interference at the receiver. In general, a 64-point IFFT will be used for 20 MHz channels and 128-point IFFT will be used for 40 MHz channels.

In one embodiment, the number of M-input paths will equal the number of P-output paths. In another embodiment, the number of output paths P will equal M+1 paths. For each of the paths, the space/time encoder multiples the input symbols with an encoding matrix that has the form of

$$[ \begin{matrix}{C}_{1} & {C}_{2} & {C}_{3} & ⋯ & {C}_{2 M - 1} \\ - {C}_{2}^{*} & {C}_{1}^{*} & {C}_{4} & ⋯ & {C}_{2 M}\end{matrix} ]$$

Note that the rows of the encoding matrix correspond to the number of input paths and the columns correspond to the number of output paths.

FIG. 4(b) illustrates the radio portion of the transmitter that includes a plurality of digital filter/up-sampling modules 195-1 through 195-m, digital-to-analog conversion modules 200-1 through 200-m, analog filters 210-1 through 210-m and 215-1 through 215-m, I/Q modulators 220-1 through 220-m, RF amplifiers 225-1 through 225-m, RF filters 230-1 through 230-m and antennas 240-1 through 240-m. The P-outputs from the other stage are received by respective digital filtering/up-sampling modules 195-1 through 195-m.

In operation, the number of radio paths that are active correspond to the number of P-outputs. For example, if only one P-output path is generated, only one of the radio transmitter paths will be active. As one of average skill in the art will appreciate, the number of output paths may range from one to any desired number.

The digital filtering/up-sampling modules 195-1 through 195-m filter the corresponding symbols and adjust the sampling rates to correspond with the desired sampling rates of the digital-to-analog conversion modules 200. The digital-to-analog conversion modules 200 convert the digital filtered and up-sampled signals into corresponding in-phase and quadrature analog signals. The analog filters 210 and 215 filter the corresponding in-phase and/or quadrature components of the analog signals, and provide the filtered signals to the corresponding I/Q modulators 220. The I/Q modulators 220 based on a local oscillation, which is produced by a local oscillator 100, up-converts the I/Q signals into radio frequency signals. The RF amplifiers 225 amplify the RF signals which are then subsequently filtered via RF filters 230 before being transmitted via antennas 240.

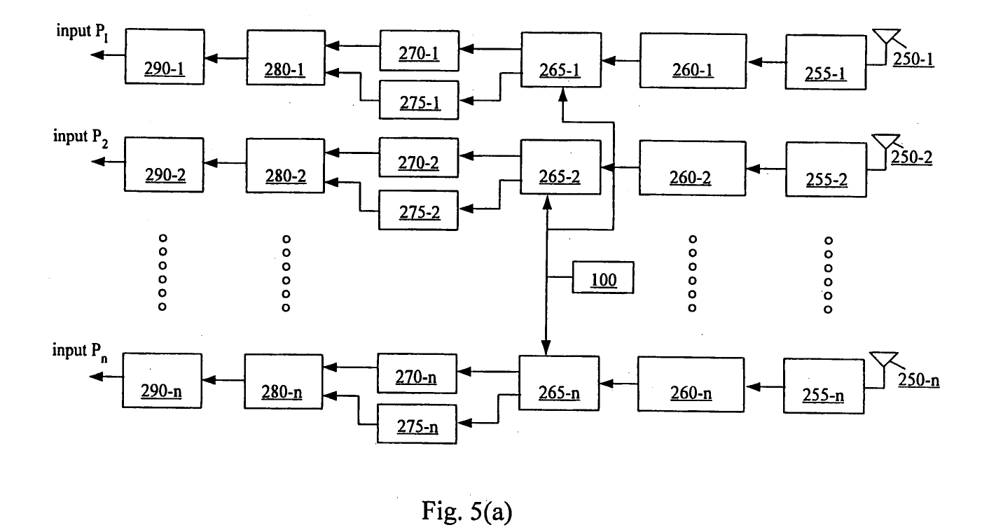

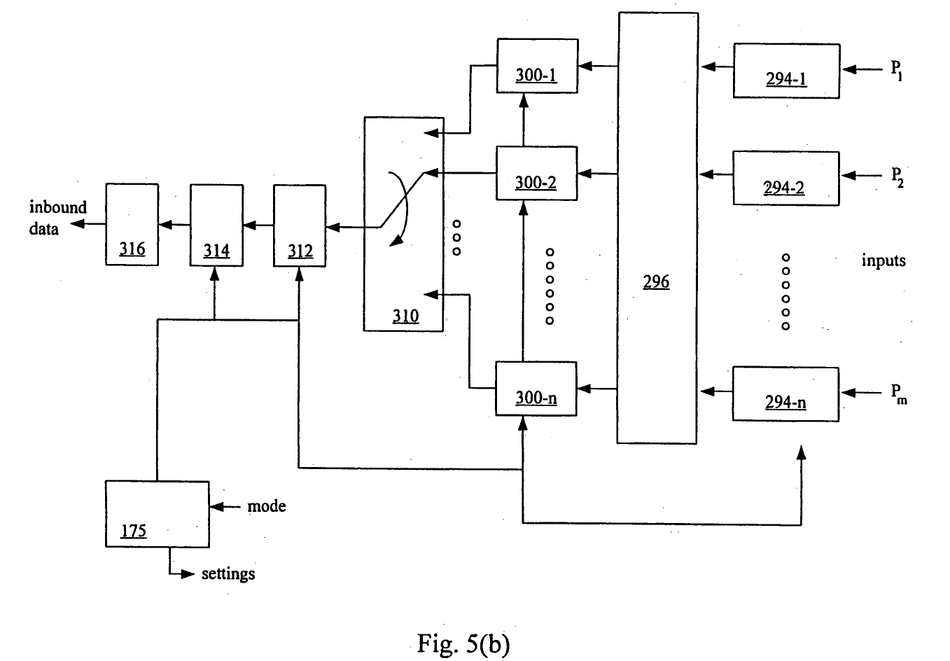

FIGS. 5(a) and 5(b) illustrate a schematic block diagram of another embodiment of a receiver in accordance with the present invention. FIG. 5(a) illustrates the analog portion of the receiver which includes a plurality of receiver paths. Each receiver path includes an antenna 250-1 through 250-n, RF filters 255-1 through 255-n, low noise amplifiers 260-1 through 260-n, I/O demodulators 265-1 through 265-n, analog filters 270-1 through 270-n and 275-1 through 275-n, analog-to-digital converters 280-1 through 280-n and digital filters and down-sampling modules 290-1 through 290-n.

In operation, the antennas 250 receive inbound RF signals, which are band-pass filtered via the RF filters 255. The corresponding low noise amplifiers 260 amplify the filtered signals and provide them to the corresponding I/Q demodulators 265. The I/Q demodulators 265, based on a local oscillation, which is produced by local oscillator 100, down-converts the RF signals into baseband in-phase and quadrature analog signals.

The corresponding analog filters 270 and 275 filter the in-phase and quadrature analog components, respectively. The analog-to-digital converters 280 convert the in-phase and quadrature analog signals into a digital signal. The digital filtering and down-sampling modules 290 filter the digital signals and adjust the sampling rate to correspond to the rate of the baseband processing, which will be described in FIG. 5(b).

FIG. 5(b) illustrates the baseband processing of a receiver. The baseband processing portion includes a plurality of fast Fourier transform (FFT)/cyclic prefix removal modules 294-1 through 294-n, a space/time decoder 296, a plurality of symbol demapping modules 300-1 through 300-n, a multiplexer 310, a deinterleaver 312, a channel decoder 314, and a descramble module 316. The baseband processing module may further include a mode managing module 175. The receiver paths are processed via the FFT/cyclic prefix removal modules 294 which perform the inverse function of the IFFT/cyclic prefix addition modules 192 to produce frequency domain symbols as M-output paths. The space/time decoding module 296, which performs the inverse function of space/time encoder 190, receives the M-output paths.

The symbol demapping modules 300 convert the frequency domain symbols into data utilizing an inverse process of the symbol mappers 180. The multiplexer 310 combines the demapped symbol streams into a single path.

The deinterleaver 312, which will be described in greater detail with reference to FIGS. 6-9, deinterleaves the single path utilizing an inverse function of the function performed by interleaver 176. The deinterleaved data is then provided to the channel decoder 314 which performs the inverse function of channel encoder 174. The descrambler 316 receives the decoded data and performs the inverse function of scrambler 172 to produce the inbound data 98.

FIG. 6 is an example of interleaving and/or deinterleaving. In this embodiment, the interleaver or deinterleaver includes memory 350 that, for example, is capable of storing 4000 bytes of data. Each byte of data is represented by a number. As shown, with option 1, the data may be read in sequentially on a row by row basis and then read on a column by column basis. Alternatively, the data may be read in on a column by column basis and read on a row by row basis. In this example, for 4K bytes of data, the latency in the receiver and the memory requirements of the receiver are greatest with respect to the other examples provided herein. Note that if the data is interleaved via option 1, it is deinterleaved via option 2, and vice versa. Further note that the 4K bytes of data may represent one frame of data.

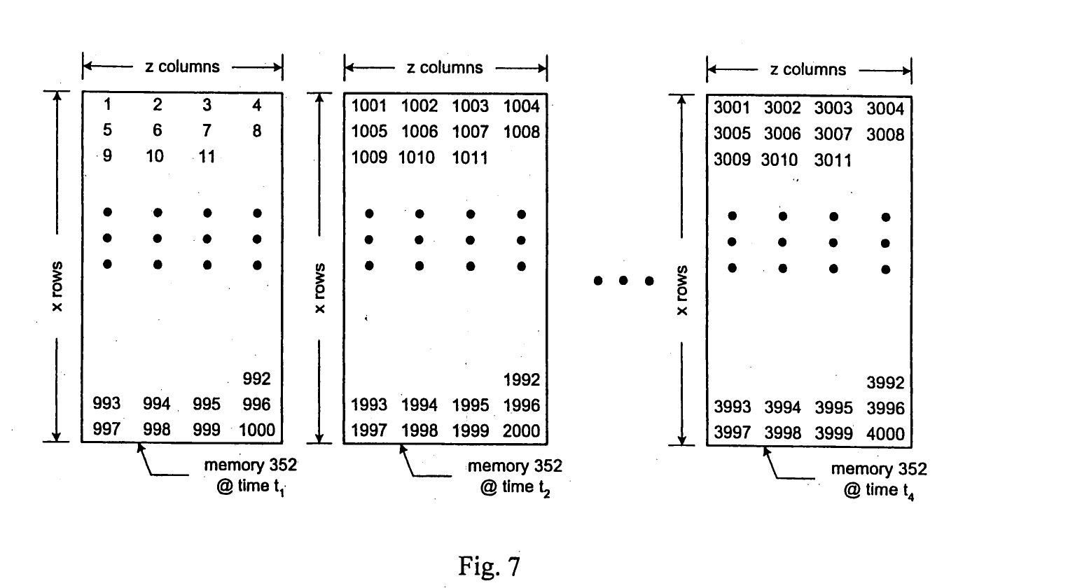

FIG. 7 is another example of interleaving and/or deinterleaving, where the interleaver or deinterleave includes memory 352, which is capable of storing 1000 bytes of information. In this example, a full frame of data includes 4K bytes of data, which is partitioned into four segments of 1000 bytes per segment. Thus, at time t1, the memory 352 stores the first 1000 bytes of a frame. The storing may be done on a row by row basis and read on a column by column basis, or vice versa. Once the memory 352 is full, at t1, it passes the data to the next stage in the baseband processing. In this instance, by passing a partially interleaved or deinterleaved frame, the latency is reduced as is the hardware requirement.

At time t2, the memory 352 stores the next 1K bytes of data in a first pattern or a second pattern, and is read in the opposite pattern. The next 1K bytes are processed at time t3 and the last 1 k bytes of data of a frame are processed at t4. In this example, the number of columns of memory 352 is a multiple of the number of columns in memory 350 for a full frame. As such, the interleaving or deinterleaving may be performed as described.

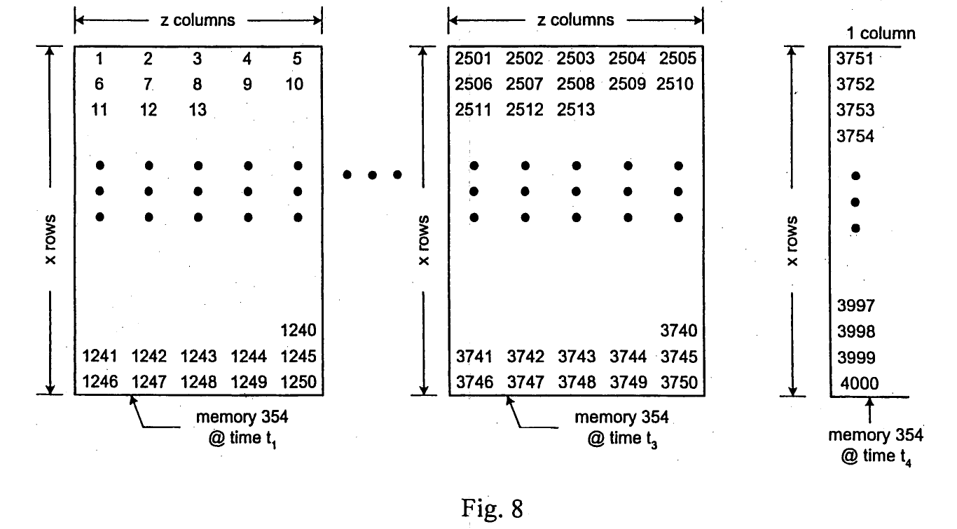

FIG. 8 is yet another example of interleaving and deinterleaving where a frame of data (e.g., 4K bytes of data) is partitioned into three equal partitions and a remainder partition. Each of the equal partitions stores 1250 bytes data, which may be stored in a row by row process and read in a column by column process, or vice versa.

The partial frame of memory 354 stores the remaining 250 bytes of data in a sequential manner. As such, the first 3750 bytes are interleaved or deinterleaved in three sections and the remaining 250 bytes are sequentially processed.

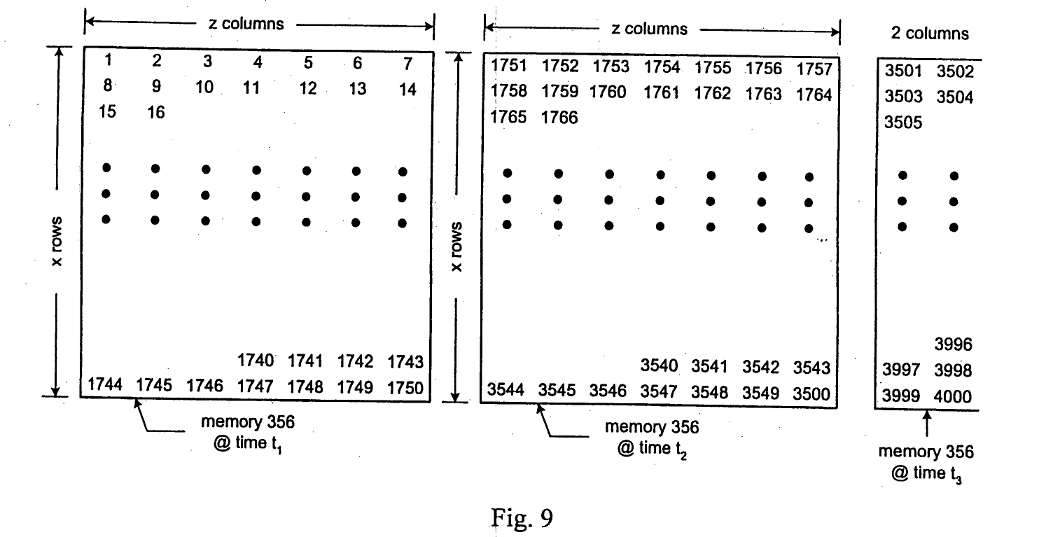

FIG. 9 is further example of interleaving and deinterleaving where a frame of data (e.g., 4K bytes of data) is partitioned into two equal partitions and a remainder partition. Each of the equal partitions interleaves or deinterleaves 1750 bytes of data on a row by row basis or a column by column basis. The remainder partition interleaves or deinterleaves two columns of data as shown.

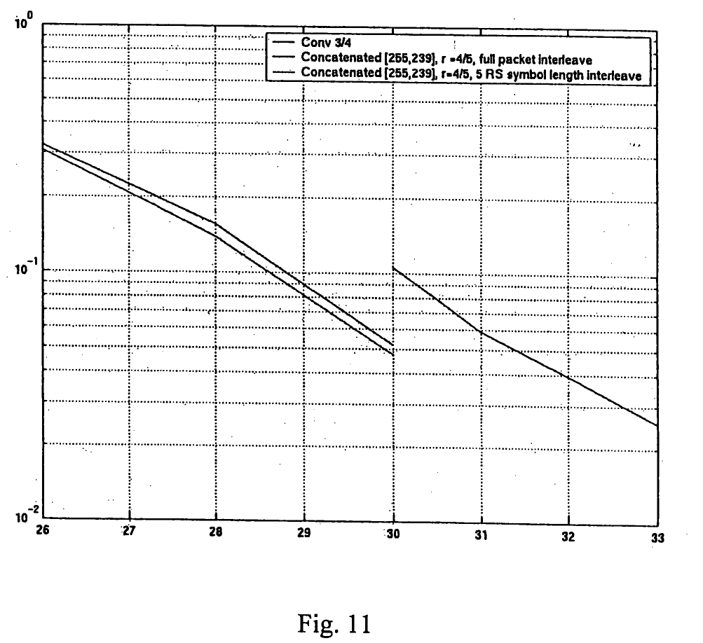

Some benefits of the instant invention include that the receiver need not wait until an entire frame is received, but can instead decode bytes to a MAC layer based on a predetermined number of symbols, or interleaver size. The interleaver size can be selected to decrease latency and improve performance, depending on the number of channels and/or the application. Comparisons of the use of the interleaving and deinterleaving according to the instant invention, when compared to other methods, are presented in FIGS. 10 and 11.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

1. A method for interleaving contents of a frame, the method comprising the steps of:
partitioning a frame into a plurality of frame segments, wherein the frame includes x rows of y columns of contents, and wherein at least one of the plurality of frame segments includes x rows of z columns of the contents, where z is less than y;
storing the x rows of z columns of the contents of the at least one of the plurality of frame segments in accordance with a first pattern to produce stored content; and
retrieving the stored content in accordance with a second pattern to produce interleaved content;
wherein x, y and z comprise integers.

2. The method of claim 1, wherein:
when y is a multiple of z, the method further comprises;
storing contents of the x rows of z columns of a first one of the plurality of frame segments in accordance with the first pattern to produce first stored content;
retrieving the first stored content in accordance with the second pattern to produce first interleaved content;
storing contents of the x rows of z columns of a second one of the plurality of frame segments in accordance with the first pattern to produce second stored content; and
retrieving the second stored content in accordance with the second pattern to produce second interleaved content.

3. The method of claim 1, wherein:
when y is not a multiple of z such that y=a*z+b, where a is whole number and b is a remainder, for each of the plurality of frame segments corresponding to the a*z term the method further comprises;
storing contents of the x rows of z columns in accordance with the first pattern to produce the stored content; and
retrieving the stored content in accordance with the second pattern to produce the interleaved content; and
for a remainder frame segment of the plurality of frames that corresponds to the b term;
storing the content of the x rows of z columns in accordance with a third pattern to produce remainder stored content; and
retrieving the remainder stored content in accordance with a fourth pattern to produce remainder interleaved content.

4. The method of claim 3 wherein:
when b equals one, the method further comprises;
storing contents of x rows of one column sequentially to produce the remainder stored content; and
retrieving the remainder stored content in a same sequential manner to produce remainder interleaved content.

5. The method of claim 3 wherein:
when b is greater than one, the method further comprises;
storing contents of x rows of b columns sequentially across the b columns from row to row of the x rows produce the remainder stored content; and
retrieving the remainder stored content sequentially down a row of the x rows from column to column of the b columns to produce remainder interleaved content.

6. The method of claim 1, wherein:
the first pattern includes storing the content of x rows of y columns sequentially across the y columns from row to row of the x rows to produce the stored content; and
the second pattern includes retrieving the remainder stored content sequentially down a row of the x rows from column to column of the y columns to produce the interleaved content.

7. The method of claim 1, wherein:
the first pattern includes storing the content of x rows of y columns sequentially down a row of the x rows from column to column of the y columns to produce the stored content; and
the second pattern includes retrieving the remainder stored content sequentially across the y columns from row to row of the x rows to produce the interleaved content.

8. A method for deinterleaving contents of a frame, the method comprising the steps of:
partitioning a frame into a plurality of frame segments, wherein the frame includes x rows of y columns of contents, and wherein at least one of the plurality of frame segments includes x rows of z columns of the contents, where z is less than y;
storing contents of the x rows of z columns of the at least one of the plurality of frame segments in accordance with a first pattern to produce stored content; and
retrieving the stored content in accordance with a second pattern to produce deinterleaved content;
wherein x, y and z comprise integers.

9. The method of claim 8, wherein:
when y is a multiple of z, the method further comprises;
storing contents of the x rows of z columns of a first one of the plurality of frame segments in accordance with the first pattern to produce first stored content;
retrieving the first stored content in accordance with the second pattern to produce first deinterleaved content;
storing contents of the x rows of z columns of a second one of the plurality of frame segments in accordance with the first pattern to produce second stored content; and
retrieving the second stored content in accordance with the second pattern to produce second deinterleaved content.

10. The method of claim 8, wherein:
when y is not a multiple of z such that y=a*z+b, where a is whole number and b is a remainder, for each of the plurality of frame segments corresponding to the a*z term, the method further comprises;
storing contents of the x rows of z columns in accordance with the first pattern to produce the stored content; and
retrieving the stored content in accordance with the second pattern to produce the deinterleaved content; and
for a remainder frame segment of the plurality of frames that corresponds to the b term;
storing contents of the x rows of z columns in accordance with a third pattern to produce remainder stored content; and
retrieving the remainder stored content in accordance with a fourth pattern to produce remainder deinterleaved content.

11. The method of claim 10, wherein:
when b equals one, the method further comprises;
storing the content of x rows of one column sequentially to produce the remainder stored content; and
retrieving the remainder stored content in a same sequential manner to produce remainder deinterleaved content.

12. The method of claim 10 further comprising, when b is greater than 1:
storing the content of x rows of b columns sequentially across the b columns from row to row of the x rows produce the remainder stored content; and
retrieving the remainder stored content sequentially down a row of the x rows from column to column of the b columns to produce remainder deinterleaved content.

13. The method of claim 8, wherein:
the first pattern includes storing the content of x rows of y columns sequentially across the y columns from row to row of the x rows to produce the stored content; and
the second pattern includes retrieving the remainder stored content sequentially down a row of the x rows from column to column of the y columns to produce the deinterleaved content.

14. The method of claim 8, wherein:
the first pattern includes storing the content of x rows of y columns sequentially down a row of the x rows from column to column of the y columns to produce the stored content; and
the second pattern includes retrieving the remainder stored content sequentially across the y columns from row to row of the x rows to produce the deinterleaved content.

15. A radio frequency (RF) transmitter, said transmitter comprising:
a baseband processing means for performing an outer encoding function on outbound data to produce outer encoded data, interleaving the outer encoded data to produce interleaved outer encoded data, and converting a portion of the interleaved outer encoded data into outbound baseband signals; and
a transmitting means for converting the outbound baseband signals into outbound RF signals;
wherein the baseband processing means further comprises;
partitioning means for partitioning a frame of the outer encoded data into a plurality of frame segments, wherein the frame includes x rows of y columns of bytes of the outer encoded data, and wherein at least one of the plurality of frame segments includes x rows of z columns of bytes of the outer encoded data, where z is less than y;
storing means for storing the bytes of the outer encoded data of the x rows of z columns of the at least one of the plurality of frame segments in accordance with a first pattern to produce stored bytes of the outer encoded data; and
retrieving means for retrieving the stored bytes of the outer encoded data in accordance with a second pattern to produce the portion of the interleaved outer encoded data.

16. The RF transmitter of claim 15, wherein, when y is a multiple of z, the baseband processing means is configured to:
store the bytes of the outer encoded data of the x rows of z columns of a first one of the plurality of frame segments in accordance with the first pattern to produce first stored bytes of the outer encoded data;
retrieve the first stored bytes of the outer encoded data in accordance with the second pattern to produce first interleaved bytes of the outer encoded data;
store the bytes of the outer encoded data of the x rows of z columns of a second one of the plurality of frame segments in accordance with the first pattern to produce second stored bytes of the outer encoded data; and
retrieve the second stored bytes of the outer encoded data in accordance with the second pattern to produce second interleaved bytes of the outer encoded data.

17. The RF transmitter of claim 15, wherein when y is not a multiple of z such that y=a*z+b, where a is whole number and b is a remainder, for each of the plurality of frame segments corresponding to the a*z term, the baseband processing means is configured to:
store the bytes of the outer encoded data of the x rows of z columns in accordance with the first pattern to produce the stored bytes of the outer encoded data; and
retrieve the stored bytes of the outer encoded data in accordance with the second pattern to produce the interleaved bytes of the outer encoded data; and
for a remainder frame segment of the plurality of frames that corresponds to the b term, the baseband processing means is configured to;
store the bytes of the outer encoded data of the x rows of z columns in accordance with a third pattern to produce remainder stored bytes of the outer encoded data; and
retrieve the remainder stored bytes of the outer encoded data in accordance with a fourth pattern to produce remainder interleaved bytes of the outer encoded data.

18. The RF transmitter of claim 17, wherein when b equals one, the baseband processing means is configured to:
store the bytes of the outer encoded data of x rows of one column sequentially to produce the remainder stored bytes of the outer encoded data; and
retrieve the remainder stored bytes of the outer encoded data in a same sequential manner to produce remainder interleaved bytes of the outer encoded data.

19. The RF transmitter of claim 17, wherein when b is greater than one, the baseband processing means is configured to:
store the bytes of the outer encoded data of x rows of b columns sequentially across the b columns from row to row of the x rows produce the remainder stored bytes of the outer encoded data; and
retrieve the remainder stored bytes of the outer encoded data sequentially down a row of the x rows from column to column of the b columns to produce remainder interleaved bytes of the outer encoded data.

20. The RF transmitter of claim 15, wherein:
the first pattern includes storing the bytes of the outer encoded data of x rows of y columns sequentially across the y columns from row to row of the x rows to produce the stored bytes of the outer encoded data; and
the second pattern includes retrieving the remainder stored bytes of the outer encoded data sequentially down a row of the x rows from column to column of the y columns to produce the interleaved bytes of the outer encoded data.

21. The RF transmitter of claim 15, wherein:
the first pattern includes storing the bytes of the outer encoded data of x rows of y columns sequentially down a row of the x rows from column to column of the y columns to produce the stored bytes of the outer encoded data; and
the second pattern includes retrieving the remainder stored bytes of the outer encoded data sequentially across the y columns from row to row of the x rows to produce the interleaved bytes of the outer encoded data.

22. A radio frequency (RF) receiver, wherein said receiver comprising:
receiver means for converting inbound RF signals into inbound baseband signals; and
baseband processing means for converting the inbound baseband signals into interleaved outer encoded data; deinterleaving the interleaved outer encoded data to produce deinterleaved outer encoded data and performing an outer decoding function on deinterleaved bytes of the interleaved outer encoded data to produce partial inbound data,
the baseband processing means further comprising;
partitioning means for partitioning a frame of the interleaved outer encoded data into a plurality of frame segments, wherein the frame includes x rows of y columns of bytes of the interleaved outer encoded data, and wherein at least one of the plurality of frame segments includes x rows of z columns of the bytes of the interleaved outer encoded data, where z is less than y;
storing means for storing the bytes of the interleaved outer encoded data of the x rows of z columns of the at least one of the plurality of frame segments in accordance with a first pattern to produce stored bytes of the interleaved outer encoded data; and
retrieving means for retrieving the stored bytes of the interleaved outer encoded data in accordance with a second pattern to produce the deinterleaved bytes of the interleaved outer encoded data.

23. The RF receiver of claim 22 wherein, when y is a multiple of z, the baseband processing means is configured to:
store the bytes of the interleaved outer encoded data of the x rows of z columns of a first one of the plurality of frame segments in accordance with the first pattern to produce first stored bytes of the interleaved outer encoded data;
retrieve the first stored bytes of the interleaved outer encoded data in accordance with the second pattern to produce first deinterleaved bytes of the interleaved outer encoded data;
store the bytes of the interleaved outer encoded data of the x rows of z columns of a second one of the plurality of frame segments in accordance with the first pattern to produce second stored bytes of the interleaved outer encoded data; and
retrieve the second stored bytes of the interleaved outer encoded data in accordance with the second pattern to produce second deinterleaved bytes of the interleaved outer encoded data.

24. The RF receiver of claim 22 wherein, when y is not a multiple of z such that y=a*z+b, where a is whole number and b is a remainder, for each of the plurality of frame segments corresponding to the a*z term, the baseband processing means is configured to:
store the bytes of the interleaved outer encoded data of the x rows of z columns in accordance with the first pattern to produce the stored bytes of the interleaved outer encoded data; and
retrieve the stored bytes of the interleaved outer encoded data in accordance with the second pattern to produce the deinterleaved bytes of the interleaved outer encoded data; and
for a remainder frame segment of the plurality of frames that corresponds to the b term, the baseband processing means is configured to;
store the bytes of the interleaved outer encoded data of the x rows of z columns in accordance with a third pattern to produce remainder stored bytes of the interleaved outer encoded data; and
retrieve the remainder stored bytes of the interleaved outer encoded data in accordance with a fourth pattern to produce remainder deinterleaved bytes of the interleaved outer encoded data.

25. The RF receiver of claim 24, wherein when b equals one, the baseband processing means is configured to:
store the bytes of the interleaved outer encoded data of x rows of one column sequentially to produce the remainder stored bytes of the interleaved outer encoded data; and
retrieve the remainder stored bytes of the interleaved outer encoded data in a same sequential manner to produce remainder deinterleaved bytes of the interleaved outer encoded data.

26. The RF receiver of claim 24, wherein when b is greater than one, the baseband processing means is configured to:
store the bytes of the interleaved outer encoded data of x rows of b columns sequentially across the b columns from row to row of the x rows produce the remainder stored bytes of the interleaved outer encoded data; and
retrieve the remainder stored bytes of the interleaved outer encoded data sequentially down a row of the x rows from column to column of the b columns to produce remainder deinterleaved bytes of the interleaved outer encoded data.

27. The RF receiver of claim 22, wherein:
the first pattern includes storing the bytes of the interleaved outer encoded data of x rows of y columns sequentially across the y columns from row to row of the x rows to produce the stored bytes of the interleaved outer encoded data; and
the second pattern includes retrieving the remainder stored bytes of the interleaved outer encoded data sequentially down a row of the x rows from column to column of the y columns to produce the deinterleaved bytes of the interleaved outer encoded data.

28. The RF receiver of claim 22, wherein:
the first pattern includes storing the bytes of the interleaved outer encoded data of x rows of y columns sequentially down a row of the x rows from column to column of the y columns to produce the stored bytes of the interleaved outer encoded data; and
the second pattern includes retrieving the remainder stored bytes of the interleaved outer encoded data sequentially across the y columns from row to row of the x rows to produce the deinterleaved bytes of the interleaved outer encoded data.

29. A radio frequency (RF) transceiver, said transceiver comprising:
a baseband processor, configured to perform an outer encoding function on outbound data to produce outer encoded data, to interleave the outer encoded data to produce interleaved outer encoded data, to convert a portion of the interleaved outer encoded data into outbound baseband signals, to convert inbound baseband signals into other interleaved outer encoded data, to deinterleave the other interleaved outer encoded data to produce deinterleaved outer encoded data and to perform an outer decoding function on deinterleaved bytes of the interleaved outer encoded data to produce partial inbound data;
a transmitter, configured to convert the outbound baseband signals into outbound RF signals; and
a receiver, configured to convert inbound RF signals into the inbound baseband signals;
wherein the baseband processor further comprises;
a partitioner, configured to partition a frame of the outer encoded data into a plurality of frame segments and to partition a frame of the interleaved outer encoded data into another plurality of frame segments, wherein the frame includes x rows of y columns of bytes of data, and wherein at least one of the plurality of frame segments and the another plurality of frame segments includes x rows of z columns of bytes of the data, where z is less than y;
a data storer, configured to store the bytes of the data of the x rows of z columns of the at least one of the plurality of frame segments and the another plurality of frame segments in accordance with a first pattern to produce stored bytes of the outer encoded data and to produce stored bytes of the interleaved outer encoded data; and
a data retriever, configured to retrieve the stored bytes of the outer encoded data and stored bytes of the interleaved outer encoded data in accordance with a second pattern to produce the portion of the interleaved outer encoded data and to produce the deinterleaved bytes of the interleaved outer encoded data.

30. The RF receiver of claim 29, wherein:
the first pattern includes storing the bytes of the interleaved outer encoded data and the bytes of the outer encoded data of x rows of y columns sequentially across the y columns from row to row of the x rows to produce the stored bytes of the interleaved outer encoded data and the stored bytes of the outer encoded data; and
the second pattern includes retrieving the remainder stored bytes of the interleaved outer encoded data and the remainder stored bytes of the outer encoded data sequentially down a row of the x rows from column to column of the y columns to produce the deinterleaved bytes of the interleaved outer encoded data and the interleaved bytes of the outer encoded data.

31. The RF receiver of claim 29, wherein:
the first pattern includes storing the bytes of the interleaved outer encoded data and the bytes of the outer encoded data of x rows of y columns sequentially down a row of the x rows from column to column of the y columns to produce the stored bytes of the interleaved outer encoded data and the stored bytes of the outer encoded data; and
the second pattern includes retrieving the remainder stored bytes of the outer encoded data and the remainder stored bytes of the interleaved outer encoded data sequentially across the y columns from row to row of the x rows to produce the interleaved bytes of the outer encoded data and the deinterleaved bytes of the interleaved outer encoded data.
